(19) United States
(12) Patent Application Publication
(10) Pub. No.: US 2004/0158852 A1
(43) Pub. Date: Aug. 12, 2004

(54) System of transmission of television programs with variable number of advertisements and method of transmission of television programs

(75) Inventor: Aleksander Wysocki, Katowice (PL)

Correspondence Address: HOFFMANN & BARON, LLP, 6900 JERICHO TURNPIKE, SYOSSET, NY, 11791, US

(73) Assignees: Advanced Digital Broadcast Polska Sp. z o; Advanced Digital Broadcast Ltd.

(21) Appl. No.: 10/748,785

(22) Filed: Dec. 30, 2003

(30) Foreign Application Priority Data
Dec. 30, 2002 (PL) P-358051

(51) Int. Cl. H04N 5/445; G06F 3/00; H04N 7/10; H04N 7/025

(52) U.S. Cl. 725/32; 725/36; 725/42

(57) ABSTRACT

The system of transmission of television programs with a variable number of advertisements comprises a transmitter (161), a receiving device (101) including a processor block (103) and an AudioNideo block (104) linked to the processor block (103) and generating signal in format acceptable to a television set. The transmitter (161) transmits a television signal including television programs, advertisements and control signals. The receiving device (101) additionally includes a signal receiving block (102), a mass storage block (105) for recording the television signal and its subsequent playback and the mass storage block. The processor block (103) comprises a signal processing block (111) for decoding and decompressing the television signal and controlling a data stream transfer, a signal reception configuration block (112) for receiving user's commands, a mass storage controller (114) for controlling data stream transfer between the processor block and the mass storage block, a marker analysis block (113) for analyzing markers broadcasted on a control channel and sending appropriate commands to the signal processing block and the mass storage block related to playback and recording of the television signal.

### CROSS-REFERENCE TO RELATED APPLICATIONS

This application claims priority to Polish Application No. P-358051, filed Dec. 30, 2002, the contents of which are incorporated herein by reference.

### BACKGROUND OF THE INVENTION

### FIELD OF THE INVENTION

The object of the invention is a system of transmission of television programs with a variable number of advertisements and a method of transmission of television programs.

Currently, among television channels, a distinction can be made between channels with high and low advertisement content. The first one contains a large number of advertisements, which allows for decreasing viewers subscription fees. This is due to all broadcast costs being covered by advertising fees. Low advertisement content makes a channel more pleasant to watch, but also forces an increase in subscription fees, the viewer must pay in order to receive it. Channels, with the most interesting programs most frequently charge the highest fees. Not all users can afford to receive such channels. Subscription fees can be reduced by broadcasting a greater number of advertisements. There exists however, a group of users, who can afford high subscription fees, and in turn expect a minimal advertisement content on a given channel. A solution to this problem is to broadcast two versions of the same channel. There are more advertisements broadcasted in one version, and the other contains less or none at all. Still, with the technical resources currently available, broadcasting a second version of the channel requires a double transmission band throughput.

The U.S. patent application No. 2002/0,083,445, entitled “Delivering targeted advertisements to the set-top box”, describes a delivery of advertisements through an additional channel, dedicated to advertisements. It only describes various advertising channel configurations. These include: an analogue channel, and digital channels with low, high or variable throughput. The mentioned description does not refer to any methods of using the advertisements, broadcasted in such a way.

The International Patent Application Publication No. WO 01/33848 A1, entitled “Method and apparatus for swapping the video contents of undesired commercial breaks or other video sequences”, presents in turn a method for replacing advertisements broadcasted in a television signal with another signal, for example a program read from a hard disk, or an application presenting a mailbox, containing the decoder user's electronic mail. In the said patent application, an apparatus for swapping the content of a video signal detects the content of a video sequence in the video signal, using extracted text and/or audiovisual features to identify the content of a video sequence. The identification of the video sequence is then compared with the user's personal profile. If the content of the sequence is undesirable, the apparatus swaps this video sequence for a desired video sequence, from a known source. The aim of this method however, is only to exchange the advertisements for other content more interesting to the user, or with other advertisements adjusted to suit the given user.

There also exist devices for recording a television signal and its subsequent playback. They are called Personal Video Recorders—abbreviated as PVR. A hard disk is the most common data carrier in these devices. The PVR allows for simultaneous recording of a currently received television program and playback of a program recorded earlier. This allows, among others, for shifting the watched program in time. This amounts to playing the program with a certain delay in relation to the broadcasted program, while maintaining continuity. An exemplary solution for a device for recording television signal and its subsequent playback is presented in the U.S. Pat. No. 5,371,551 (Re. 36,801) “Time delayed digital video system using concurrent recording and playback”. The patent specification describes a broadcast recording and playback device employing a circular buffer, which constantly records one or more incoming audio or video program signals, and a microprocessor for accessing the memory needed to read a playback signal from the circular buffer to display programming material delayed from its receipt by a selectable delay interval. The circular buffer is implemented by digital memory. Subsystem comprising the combination of a semiconductor RAM memory and a disk memory operated under the control of a microprocessor, such that the incoming signals are constantly recorded as received while the delayed signals are being read from the memory subsystem at a different memory location, selected by the microprocessor, to provide a user-selected time delay. The main point here is that, in the system of transmission of television programs with a variable number of advertisements—composed of a transmitter, transmitting television programs and advertisements and devices receiving television programs and advertisements—the transmitter contains a system for broadcasting a signal controlling the number of displayed advertisements, and that the devices receiving the television programs contain a system for receiving the signal controlling the number of broadcasted advertisements.

### SUMMARY OF THE INVENTION

### PRUPOSES OF THE INVENTION

It is an object of this invention to provide a device for controlling a number of advertisements displayed during watching TV that allows for easier choosing of quantity of advertisement in a transmitted program.

It is another object of this invention to provide a method for easy controlling a number of advertisements displayed in dependency of chosen variant of pre-paid payment.

These and other objects and advantages of the present invention will become apparent from the detailed description, which follows.

### BRIEF DESCRIPTION OF THE INVENTION

In a system and a method of transmission of television programs with a variable number of advertisements, television programs are transmitted on primary channels, advertisements are transmitted on a channel with advertising units, and the signal controlling the quantity of displayed advertisements is transmitted on a control channel.

The control channel can include markers of programs P, controlling the record of a signal from the primary channel as well as the markers of advertisements R, controlling playback of the recorded signal or of the advertisement.

In the case, when the interval between the recording and playback of the recorded signal is shorter than a specified time, the recorded signal is stopped, and the signal from the primary channel is played.

A list of advertisements, which are to be played during the advertising break, can be broadcasted along with the marker of the advertisement R.

In the case when the marker of the advertisement R becomes inactive, the currently played advertisement is played until the end, and after it is finished, the playback of the recorded program is continued.

Advertisements can be formed into advertising units, marked with markers comprising a segment code—defining the products' main segment—a sub-segment code—defining in detail the category of the product in a given segment—a code of the manufacturer of the product, and an advertisement code—identifying a given manufacturer's advertisement, from a specified segment.

At choosing the advertising unit to be displayed, it is checked if it is not a unit competitive to the previously displayed one.

Television programs can be transmitted on the primary channel, together with the signal controlling the quantity of displayed advertisements. Advertisements can be transmitted on the channel with advertising units. The advertisements can be displayed in a specified location on the screen along with the display of television program.

The advertisements can be displayed after activating the control signal by means of an appropriate key on the remote control unit, or when a channel containing advertisements is chosen.

The control signal, controlling the number of displayed advertisements can be generated in the device receiving the television programs. The device has a control channel assigned to it in that signal. The control signal will preferably include: P and R markers, which cause an intermission in displaying the signal from the primary channel and start the display of advertisements, markers causing the background recording of the signal from the primary channel on a data carrier, markers causing the playback of signal from primary channel, markers causing the playback of signal from the data carrier, as well as markers stopping the background recording of the signal from the basic channel on the data carrier.

The system of transmission of television programs with a variable number of advertisements comprises a transmitter, a receiving device including a processor block and an Audio/Video block linked to the processor block and generating signal in format acceptable to a television set. The transmitter transmits a television signal including television programs, advertisements and control signals. The receiving device additionally includes a signal receiving block, a mass storage block for recording the television signal and its subsequent playback and the mass storage block. The processor block comprises a signal processing block for decoding and decompressing the television signal and controlling a data stream transfer, a signal reception configuration block for receiving user's commands, a mass storage controller for controlling data stream transfer between the processor block and the mass storage block, a marker analysis block for analyzing markers broadcasted on a control channel and sending appropriate commands to the signal processing block and the mass storage block related to playback and recording of the television signal.

The novel features, which are considered as characteristic for the invention are set forth in the appended claims. The invention itself, however, both as to its construction and its method of operation, together with additional objects and advantages thereof, will be best understood from the following description of specific embodiments, when read in connection with the accompanying drawings.

### BRIEF DESCRIPTION OF THE DRAWINGS

In the accompanying drawings one of the possible embodiments of the present invention is shown, where

FIG. 1 is a block diagram of a device receiving television programs;

FIG. 2 shows a structure of an advertising unit;

FIG. 3 shows an example of an identifier unit;

FIG. 4 shows schematically a program transmitted on a primary channel interrupted with advertisements;

FIG. 5 shows schematically a program transmitted on a primary channel not interrupted with advertisements;

FIG. 6 is a flow chart of an operation of a system handling two channels;

FIG. 7 is a flow chart of a procedure for choosing an advertisement; and

FIG. 8 is a flow chart of a procedure for changing a channel.

### DESCRIPTION OF INVENTION AND PREFERRED EMBODIMENT

In the simplest solution of the system of television program transmission with a variable number of advertisements, the transmitter transmits the signal, controlling the number of displayed advertisements, together with the television program and the advertisements. Devices receiving the television programs and advertisements contain a system for receiving the signal controlling the number of displayed advertisements.

The solution, which is particularly suitable for application in digital television, is based on a system of broadcasting television channels in two versions, with the second version utilizing only a fragment of the band, occupied by the primary channel. In the system, the primary channel is broadcasted with very few advertisements (or none at all), and the channel controlling the display of the second channel, with higher advertisement content. There are markers broadcasted in the broadcasting channel, which cause the playback of advertisements at a specified time. During the playback of the advertisement, signal from the primary channel is recorded in the memory of the decoder, and afterwards played with a delay. Advertisements, displayed on the second channel are drawn from the decoder memory, according to the user preferences.

There are many advantages of the different versions of one program being available to the user. The main ones relate to the differentiation of television fees. For example, when the user cannot afford the high fee for watching an interesting program, he or she can choose to change to a less expensive channel, showing the same program, but with a higher advertisement content.

Moreover, additional special programs may be shown on the primary channel, as an interlude between the scheduled ones. These may, for instance, include additional information about the program just shown, or other informational programs. Such programs would only be available to the users receiving the primary channel. Only advertisements would be broadcasted on the advertising channel at this time. There is also a possibility of merging the solution proposed here with the ‘Pay-per-view’ system, in which the users are charged with fees only for programs they have watched. Combining the two systems allows for the possibility of differentiating the fees for watching an advertising-free program from the usual fees charged by the channel from which the given program was received.

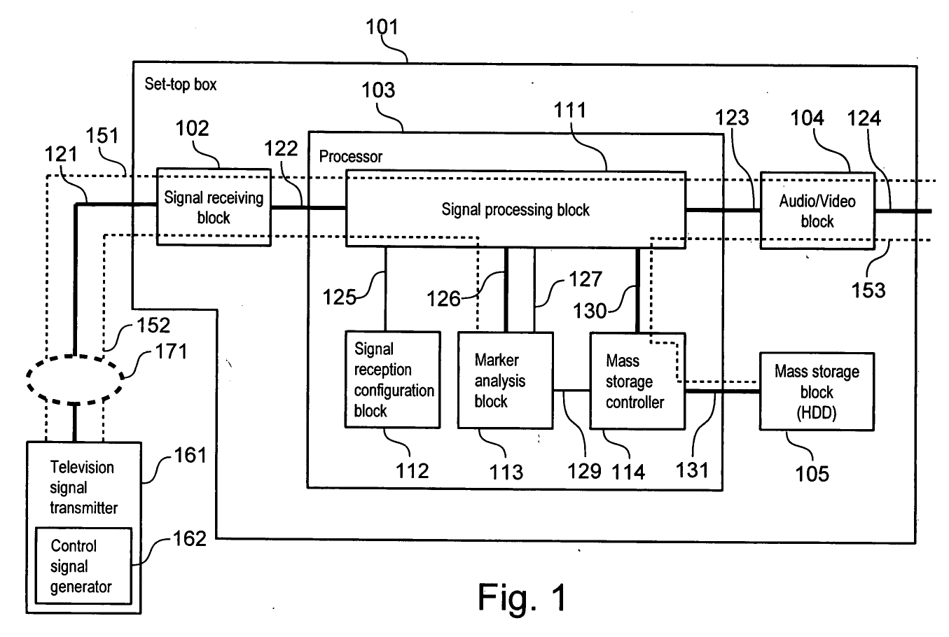

FIG. 1 shows the structure of a device receiving a television signal. That device is a decoder or a set-top-box 101, with a built-in system for recording television signal and its subsequent playback. The decoder 101 has a signal receiving block 102, a processor block 103, an AudioNideo block 104—responsible for generating signal in format acceptable to a television set—and a mass memory block 105, which functions as a device for recording the television signal and its subsequent playback, used by the PVR software and installed in the decoder—usually a hard disk. The components of the signal receiving block 102 include tuners and demodulators, which transform the signal from an analogue form into a digital form. The processor block 103 deals with signal processing (among others, with the decompression of the MPEG signal) and also executes the decoder software. Among the components of the processor block 103 are the following: a signal processing block 111, responsible for operations on the received signal, such as decoding and decompressing the received signal, as well as controlling the data stream transfer to other blocks; a signal reception configuration block 112, which receives the user's commands, provided the means of a remote control unit, as to the channel, which is to be displayed on the screen of the television receiver. There are also: the mass storage controller 114—controlling the data stream transfer between the processor 103 and a mass memory block or a mass storage block 105—and the marker analysis block 113, which analyzes the markers broadcasted on the control channel, and—based on them—sends appropriate commands, related to the playback and recording of the signal, to the signal processing block 111 and to the mass storage controller 114. The above blocks should be treated as functional blocks, in their actual implementation they can be joined together or split into smaller modules.

By the means of the control signal generator 162—generating a signal controlling the number of displayed advertisements—the television signal stream 121, is transmitted through a cable, terrestrial or satellite television network 171, from a television signal transmitter 161, transmitting the television program and advertisements. This stream is received by signal receiving block 102, where it is processed into a digital television signal stream 122, comprising the primary channel, the advertisement channel and the control channel signals. The digital stream 122 of television signal is then processed into a decoded digital signal 123 to be displayed on the screen of the television receiver. Advertisements can be displayed on the screen after breaking a program or at a settled place during displaying the program. The decoded digital signal 123 is next processed into a signal 124 in a form acceptable by the receiver (for example PAL, SECAM, NTSC). Moreover, the signal processing block 111 receives commands 125, given by the signal reception configuration block 112, choosing the reception signal, and commands 127, given by the marker analysis block 113. The signals processing block 111, in turn transmits, the control channel signal 126 to the marker analysis block 113, from which commands 129, are issued to the mass storage controller 114. Aside of the above described signals and commands, sent between the signal processing block 111 and mass storage block 105, a television data stream 130 and 131, is also transmitted. The mass storage block 105 and the signal processing block 111 can also be connected directly to a data bus. The mass storage controller 114 would then only control the data transfer.

Thus, when the primary channel signal is directed to the mass memory block, it is transmitted by the way of streams 121, 122, 123, and 124, or 121, 122, 130, and 131. Advertisements, in turn, are received from the channel transmitting advertising units, in the television signal stream, by the way of streams 131, 130, 123, and 124. Three signals can be displayed in the channel containing advertisements. They are: the primary channel signal (via streams 121, 122, 123, and 124), the primary channel signal, played with a delay—this is a signal from the mass memory block (via streams 131, 130, 123, and 124), and the advertisement signal, played from the mass memory block, transmitted via streams 131, 130, 123, and 124. In the decoder illustrated in FIG. 1, one can distinguish the path 151 of signal transfer from the primary channel to the television set, the path 152 of control signal transfer, and the path 153 of the advertisement channel transfer. Advertising materials, designated to be displayed when a television channel is watched, are sent in a separate channel or in the advertisement channels. Depending on the needs, the operator can set one common advertising channel, in which advertisements will be broadcasted for various television channels together, or assign separate advertising channels.

In the first case, advertisements allocated to all television channels are subject to being recorded on the disk, regardless which channel is currently being watched. The dataflow in such channel is relatively high and requires increased activity of the memory system (for example the hard disk). This solution however, guarantees the availability of the majority of advertising units.

In the second case, the only advertisements recorded on the disk, are those broadcasted on an auxiliary channel, dedicated to a single, currently watched television channel. The volume of data transfer for each of the advertising channels is small—approximately proportional to the percentage of advertisements in relation to the whole audiovisual broadcast of this television channel. In this solution, advertisements for a television channel, which was not watched for a longer period of time, become available after some time that the channel is chosen. That is because the decoder has to read them from the advertising channel.

In order to permit the broadcast of the advertisement channel in streams other than the primary channel, the signal reception block and the processor must allow for the processing of two television signal streams simultaneously—this can be possible, for example, when two tuners and demodulators are included in the signal reception block, and a processor capable of processing multiple streams simultaneously (for example, the STMicroelectronics ST5514 processor).

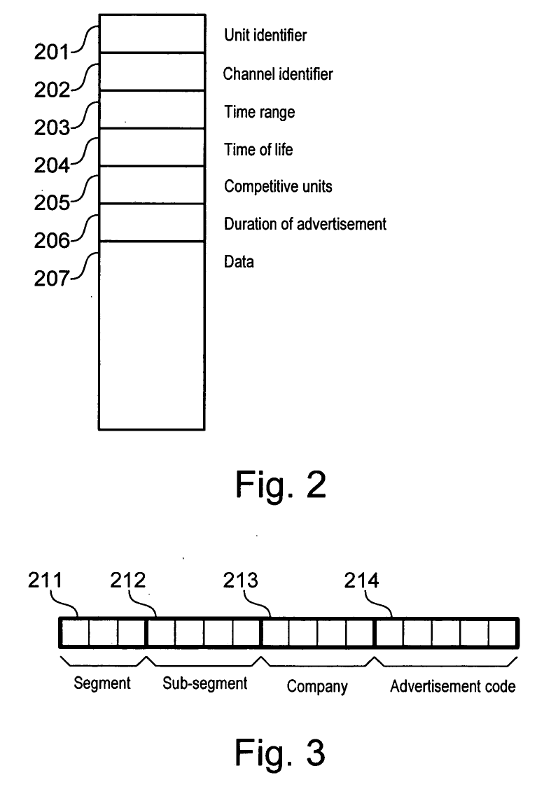

Each advertising unit constitutes a single advertising film, which is independent and different from advertisements of other products and other, even similar, advertisements of the same product. The structure of the advertising unit is illustrated in FIG. 2. Such unit consists of a header and data. The header comprises the following fields. There are a unit identifier 201 (unique for every unit), and a channel identifier 202, or a list of identifiers of the channels to which the given unit is assigned. A time range 203 defines the hours, or times of the day when the given advertisement is to be broadcasted. A expiration date 204—determining the date after which the advertisement is to be removed from the advertisement set and no longer displayed (it thus defines the time advertisement can be deleted from decoder memory). Units 205 are a listing of competitors to a given advertisement. This field allows for avoiding direct mutual proximity of advertisements of similar or competition products of competing manufacturers, or other such clashes, in the composition of consecutive advertising films. During the automatic generation of a series, of advertisements, this field will allow the decoder to set the series, in order to avoid undesirable combinations. A unit 206 is the duration of a given advertisement. Following the header, there is the data block 207, which constitutes the content of the advertisement.

The operator can define the method of identifying a unit himself. FIG. 3 shows an example of an identifier unit. Besides providing unique unit identification, it allows for comparing the advertisements semantically and applies more advanced rules of choosing. It comprises of the following fields:

a 3-symbol segment code 211, defining the main product segment, to which the given advertisement is related (e.g., 111—motor vehicles, 222—food products, 333—products for children);

a 4-symbol sub-segment code 212, specifying the detailed product category in a given segment (in the motor vehicles segment for example, 1001 may be the code for sports cars, 1002 for off-road vehicles, and 2003 for trucks);

a 4-symbol product manufacturer code (for example, 1001 may stand for company X, and 1002 for company Y);

a 5-symbol code 213, identifying a specific manufacturer's advertisement in a given segment.

The identifiers of channels, to which the given unit is assigned, can be given in form of a defined channel numbers list, or in terms of channel categories, or even as categories of programs shown on those channels. For example, a unit may be assigned to channels No. 23 and 45, or to sport programs, or to news programs. The time range, which defines the broadcasting time of an advertisement, may also be given in a form of a list, either defining the hours when the advertisement are to be broadcast on (e.g. 12.00-18.15), or specific days (e.g. Monday, 12.00-22.00). A given advertisement's competition units may be specified by providing a list of identifiers or samples of identifiers of competition units. For example, in the previously mentioned identifier recording, considering the above description of, if this list contains the element 111xxxxxxxxxxxxx—it will mean that all units related to the motor vehicles segment are going to be treated as competition units.

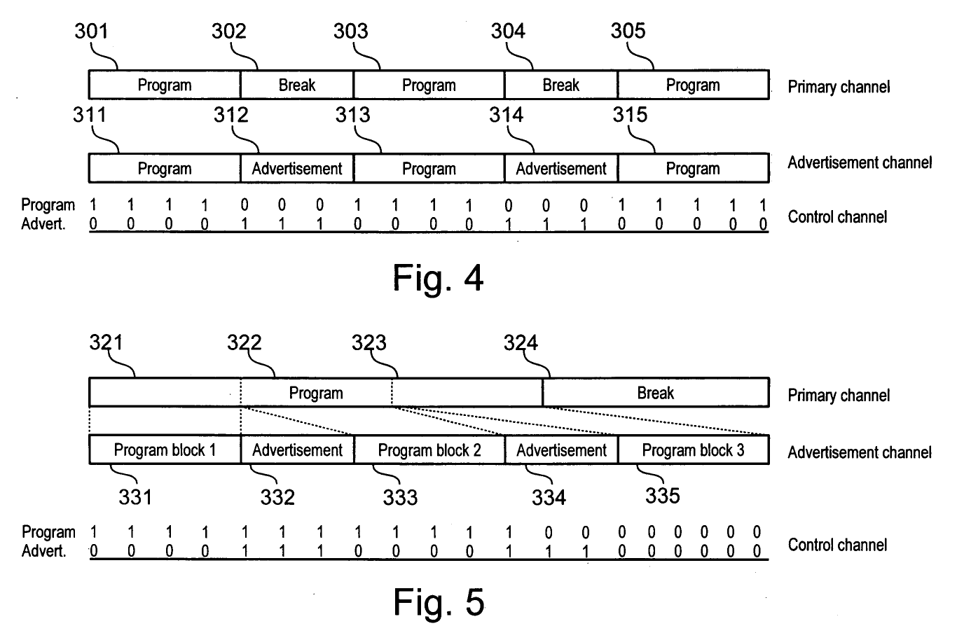

Contents of the primary television channel are transmitted in a standard way. The second channel, the advertising channel, is created in the decoder based on information broadcasted in the control channel. Examples of broadcasting the primary channel and the advertisement channel are shown in FIGS. 4 and 5. The markers P and R, are broadcasted in the control channel. They define whether the primary channel is currently broadcasting a program (marker P then equals 1), or an intermission (P=0), and whether the advertisement is currently playing an advertisement (R=1), or not (R=0). Since the control channel broadcasts markers, it occupies a small part of the band, compared to the primary channel. When the broadcasted marker P=1, it causes the PVR system to do a background recording the primary channel signal. When the marker P=0, the background recording of the signal is stopped. When the broadcasted marker R=1, it causes an intermission in the primary channel signal playback, and the start of advertisement displaying. Marker R=0 causes primary channel signal playback. FIG. 4 shows a situation, where the program 301, 303, 305, 311, 313, and 315, on the primary channel, is interrupted with intermissions. These may be, for example, informational intermissions 302, 304, or advertisement insertions 312, 314. When a program is being broadcasted, the marker P=1. When an insertion is broadcasted, the marker P=0. While the primary channel is broadcasting insertions, the advertisement channel broadcasts advertisements (R=1).

FIG. 5 shows a situation, where the program 321, 322, and 323 on the primary channel is not interrupted with advertisements, while being broadcasted. An inter-program interlude 324 is broadcasted after the program has finished. It may include cultural material, a news show etc. The interlude's duration will be equal to the advertisements 332, 334, broadcasted on the advertisement channel. Users, who receive the version of the channel containing advertisements, will watch advertisements 332, 334, while watching the program broadcasted in blocks 331, 333, 335. In another solution, the advertisement 332 will be displayed in some specified location on the television receiver screen, in a box of specified dimensions, during the display of the program 322, without interrupting it. Advertisements may be displayed following their activation by the means of a special remote control button or after changing to a certain channel.

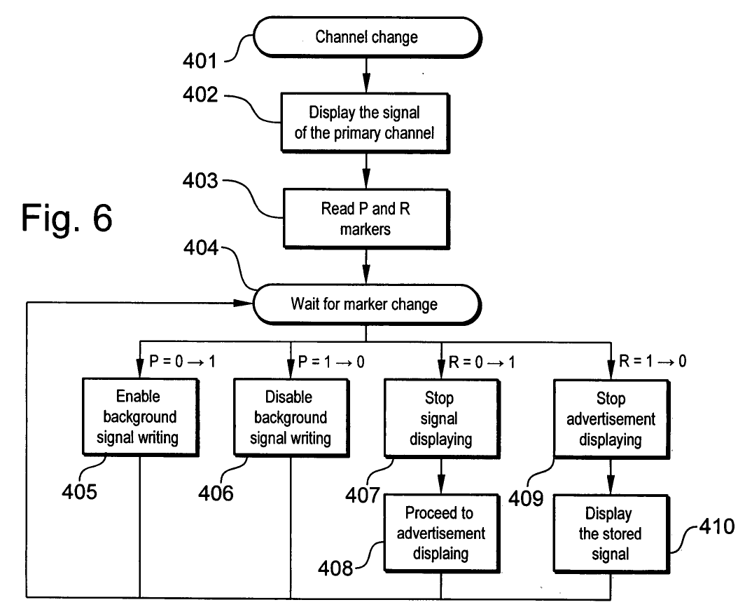

FIG. 6 shows a flow diagram illustrating the operation of a system handling two channels. Handling the two channels starts, when the user chooses a specific channel in step 401. In step 402 the system initiates the playback of the signal from the primary channel. Next, in step 403, the system reads the closest broadcasted values of the markers P and R. Then, in step 404, the system monitors the upcoming markers in the control channel and observes their change. A change in the marker P from 0 to 1 causes, in step 405, activation of signal recording from the primary channel to the memory. A change in the marker P from 1 to 0, causes—in step 406—the recording from primary channel to the memory to be discontinued. A change of the marker R from 0 to 1 causes—in step 407—a suspension of signal playback from the memory and the start of the procedure of advertisement playback in step 408. A change of the marker R from 1 to 0 causes—in step 409—a suspension of the procedure of advertisement playback, and—in step 410—the playback of the signal recorded in the memory. Step 409—the playback of the signal recorded in the memory—is based on checking whether a program is recorded in the memory. If so, it is played. If it is not, then the signal broadcasted on the primary channel is played. Signal from the primary channel is also played when the program drawn from the memory is finished.

In order to relieve the memory from constant data recording and reading, it is possible, during the reading, to check, if the difference between the broadcasting time of the currently played program content and the present time, is lower than a specified value, for example 1 second. This means that a small time shift has occurred between the command to start recording the signal to memory and its playback. If such a break occurs, the recording of the signal in the background should be switched off, and a transition should be made to playback directly from the primary channel.

In the situation, illustrated in FIG. 5, where the user changes to a different channel, while the program is played with a delay (for example after the first advertising intermission), the decoder should continue to record the contents of the current channel.

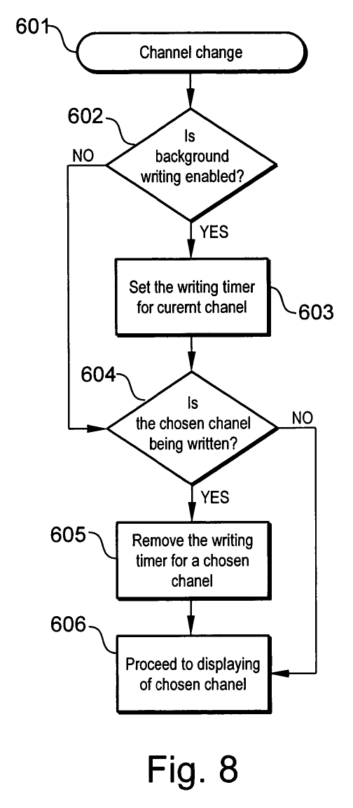

FIG. 8 shows the procedure of channel changing. This procedure is initiated, in step 401, after the user has chosen a channel, and it takes place before the procedure illustrated in FIG. 6. After step 601, where the command of selecting a new channel is made, the procedure checks—in step 602—if the background recording of the program from the currently chosen channel is switched on. If so, in step 603, the procedure sets the recording timer for recording the contents of the current channel. Such timer can be set, for example, for 3 minutes. From this moment on, the timer counts down the set time. When it gets to zero, it stops recording the signal from the channel, for which it was set. This recording becomes inactive and other signal can be recorded in its place. In step 604, a check is conducted to see, if the newly chosen channel has background recording set. If so, the timer of this channel is deleted, in step 605, because in a moment it will become an active channel. In the last step, 606, a transition is made to display the selected channel, in accordance with steps from the procedure in FIG. 6. Thanks to this procedure, when the user changes from a channel, from the one the signal of which is being recorded, to another channel, for a time not exceeding 3 minutes, the channel's signal will continue to be recorded. When the user returns to this channel, he will be able to watch the program, the signal of which was being recorded, from the point he or she has left off.

In order of allowing the procedure to be operated by the decoder, the signal receiving block and the PVR system must be able to service as many streams as many programs simultaneously recorded are there, along with the stream of the currently displayed channel. The broadcasting of advertisements starts with the detection of the beginning of the advertising block (change of the marker R from 0 to 1). After being chosen, an advertisement is displayed. The procedure of advertisement playback consecutively selects advertisements and plays them, until such a time, when a command to stop advertisement playback occurs (change of the marker R from 1 to 0). There are two methods of concluding this procedure. In the easiest method, the display of advertisement is switched off on the arrival of the command to discontinue display. This method proves good in the case when advertisements have identical length, and the length of the advertising block is a multiple of the length of the advertisements. It may also happen, that advertisements have different lengths, and the length of the advertising block is not a multiple of their length. In such case, the command to suspending the procedure of advertisements playback causes the termination of their playback, only at such a time when the playback of currently broadcasted advertisement is concluded. Only after its conclusion, the system comes to playback of the program.

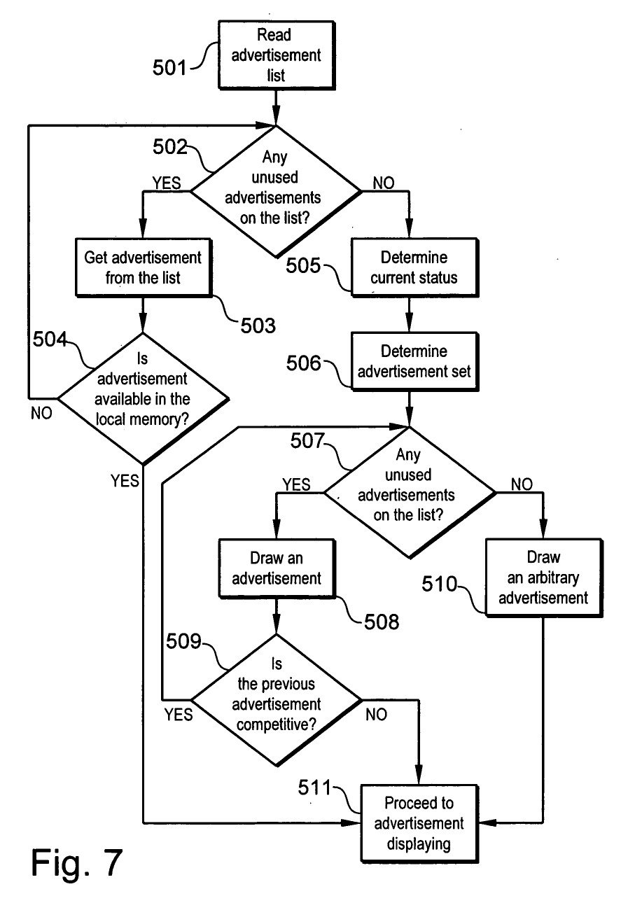

A list of preferred advertisement indicators can be sent in the control channel, along with the marker indicating that an advertisement has been sent (R=1). The advertisements requested, by the operator, will be then displayed first. If these advertisements are not recorded in the local memory, or if the list of advertisements is finished, other advertisements are played from the advertisement set available in the local memory. The flow diagram, for choosing an advertisement, is presented in FIG. 7. It begins in step 501, with the reading of the list of advertisements, requested by the operator, which is broadcasted in the control channel. If such a list exists and if it contains advertisements unused in the current advertisement break—which is checked in step 502—the next consecutive advertisement is drawn from the list in step 503. In step 504, the procedure checks, if this advertisement is available in the local memory. If so, the procedure concludes and the advertisement is displayed in step 511. If the operator's list does not exist, or if all of its advertisements have been used, the procedure reads the current conditions, in step 505. These conditions are the number of the currently chosen channel and the current time. Next, after defining the set of advertisements in step 506, it chooses from the set of available advertisements the ones, which fulfill the current conditions. Then, if such advertisements do exist and they have not yet been used, which is checked in step 507, one of them is chosen, at random, in step 508. The procedure then checks, in step 509, if the previously shown advertisement is not a competition advertisement, and inversely, if this advertisement is not a competition to the previous one. This is done by comparing the advertisement's identifier fields with the list of competition advertisements. If it is not, the advertisement will be displayed in step 511. If the advertisement is a competition one, another advertisement is chosen from the set, also at random. If the set is empty (when there are no advertisements fulfilling the conditions, or if all advertisements have been used), any random advertisement from the set of advertisements, available in the local memory, is chosen in step 510, and then displayed in step 511. The procedure of choosing the advertisements can be complemented by the possibility of the user making a choice as to the type of advertisements, which are to be displayed. The user may, for instance, decide that he or she would like to watch advertisements from the child products segment. The user could also decide on the list of segments, out of which he or she would like to watch advertisements or to block segments, which he or she does not find interesting. The method for choosing the type of advertisement is self-evident and is based on known solutions, that is why it has not been presented in a diagram.

During the reception of the television signal, a procedure is active in the background, which monitors the advertisement channel—that is, the general advertisement channel or an advertisement channel assigned to the currently watched primary channel. Advertising units are drawn from this channel and recorded in the local memory. If there is no space in the local memory, new units are recorded in place of the oldest or in place of the ones, the validity of which is about to run out. The operation method of such a procedure is well known and self-evident. Equally obvious is the operation method of the procedure for deleting advertising units, the validity of which has expired. Such procedure can be initiated, for instance, once a day. It reviews the advertising units, checking their expiration dates. In the case it finds an expired unit, it deletes it from the memory. There is also a version of such a system possible, where multiple versions of the advertisement channel are being broadcasted. This requires applying a separate control channel for each of the new advertising channels. The advertisement and program markers in each of the control channels may be broadcasted at different times. Furthermore, separate lists of available advertisements may be transmitted for each such channel.

The preferred embodiments having been thus described, it will now be evident to those skilled in the art that further variation thereto may be contemplated. Such variations are not to be regarded as a departure from the invention, the true scope of the invention being set forth in the claims appended hereto.

What is claimed is:

1. A system of transmission of television programs with a variable number of advertisements comprising:
a transmitter, transmitting a television signal including television programs, advertisements and control signals;
a receiving device comprising
a signal receiving block,
a mass storage block for recording the television signal and its subsequent playback, and
a processor block linked to the signal receiving block and the mass storage block, the processor block comprising a signal processing block for decoding and decompressing the television signal and controlling a data stream transfer, a signal reception configuration block for receiving user's commands, a mass storage controller for controlling data stream transfer between the processor block and the mass storage block, a marker analysis block for analyzing markers broadcasted on a control channel and sending appropriate commands to the signal processing block and the mass storage block related to playback and recording of the television signal,
an AudioNideo block linked to the processor block and generating signal in format acceptable to a television set.

2. The system of transmission of television programs according to claim 1, wherein television programs are transmitted on primary channels, advertisements are transmitted on a channel with advertising units and a signal controlling quantity of displayed advertisements is transmitted on a control channel.

3. The system of transmission of television programs according to claim 2, wherein a signal controlling quantity of displayed advertisements includes program markers P controlling record of a signal from a primary channel and advertisement markers R controlling playback of a recorded signal or of an advertisement.

4. The system of transmission of television programs according to claim 3, wherein the recorded signal is stopped, and the signal from the primary channel is played, when an interval between recording and playback of the recorded signal is shorter than a specified time.

5. The system of transmission of television programs according to claim 1, wherein advertisements are formed into advertising units marked with markers comprising of a segment code defining the products' main segment, a sub-segment code defining in detail category of the product in a given segment, a code of the manufacturer of the product, and an advertisement code identifying a given manufacturer's advertisement from a specified segment.

6. The system of transmission of television programs according to claim 3, wherein a list of advertisements, which are to be played during an advertisement break, is broadcasted together with the marker of the advertisement R.

7. The system of transmission of television programs according to claim 3, wherein a currently played advertisement is played until the end, and after it is finished, playback of a recorded program is continued, when the marker of the advertisement R becomes inactive.

8. The system of transmission of television programs according to claim 5, wherein at choosing the advertising unit to be displayed, it is checked if it is not a unit competitive to a previously displayed unit.

9. The system of transmission of television programs according to claim 1, wherein television programs are transmitted on the primary channel together with the signal controlling the quantity of displayed advertisements and advertisements are transmitted on the channel with advertising units.

10. A method of transmission of television programs with a variable number of advertisements comprising:
transmitting television programs and advertisements on a primary channel;
transmitting a control signal causing displaying of advertisements;
displaying the advertisements based on the control signal.

11. The method of transmission of television programs according to claim 10, wherein the advertisements are displayed on a television screen after breaking a displayed program.

12. The method of transmission of television programs according to claim 10, wherein the advertisements are displayed on a television screen at a settled place during displaying a program.

13. The method of transmission of television programs according to claim 10, wherein the advertisements are displayed following their activation by a remote control button.

14. The method of transmission of television programs according to claim 10, wherein the advertisements are displayed after switching to a certain channel.

15. The method of transmission of television programs according to claim 10, wherein the advertisements to be displayed are transmitted on an advertisement channel, stored on a mass storage device and displayed after activation by a marker of the advertisements.

16. The method of transmission of television programs according to claim 10, wherein the control signal, controlling quantity of displayed advertisements, includes program markers P and advertisement markers R causing a break in displaying the program signal from the primary channel and activating displaying the advertisements, markers activating background recording of a signal from the primary channel on a data carrier, markers activating playback of a signal from the primary channel, markers activating playback of a signal from the data carrier and markers stopping the background recording of the signal from the primary channel on the data carrier.
